(19) United States
(12) Patent Application Publication
(10) Pub. No.: US 2006/0109120 A1
(43) Pub. Date: May 25, 2006

(54) RFID tag in a substrate

(76) Inventors: Jeremy Burr, Portland, OR (US); Joshua Posamentier, Oakland, CA (US); Badari Kommandur, Hillsboro, OR (US); Lew Adams, Carmel, CA (US); Richard A. Tyo, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/993,758

(22) Filed: Nov. 19, 2004

(51) Int. Cl. G08B 13/14

(52) U.S. Cl. 340/572.1

(57) ABSTRACT

A radio frequency identification (RFID) antenna and/or RFID tag circuit may be fabricated on a substrate. The substrate may be a wafer, a die created from a wafer, or an integrated circuit package substrate. The RFID tag may also be distributed between the die and the package substrate in an integrated circuit package. In some embodiments the RFID tag may be fabricated in the lower layers of the substrate and become operational before the rest of the circuitry on the substrate has been fabricated.

### BACKGROUND

During the manufacturing process for integrated circuits, many copies of a circuit are typically fabricated on a wafer, which is then separated into individual dies, and each die is packaged to form an individual integrated circuit. Any automated tracking that is done of the wafer, individual dies, or individual integrated circuits, is typically done by either placing the object in a container that is then tracked, or by applying a bar code label to the object that can then be read with a bar code reader. However, bar codes labels are rather large compared to the size of a die or integrated circuit, and may be impractical for this purpose, while the attachment of anything to a wafer before processing might introduce unacceptable contamination and also be otherwise impractical. In addition, bar code readers require line-of-sight proximity to the bar code label, a fact that may require special handling of the objects to be read.

Passive radio frequency identification (RFID) technology can also be used to identify individual objects and does not require line of sight proximity to the tags for operation. However, RFID tags are typically manufactured and sold as discrete devices with a circuit and an antenna, and each such discrete device is later attached to whatever object is to be identified by an RFID reader. Such attachment is not feasible during much of the integrated circuit fabrication process.

### BRIEF DESCRIPTION OF THE DRAWINGS

The invention may be understood by referring to the following description and accompanying drawings that are used to illustrate embodiments of the invention. In the drawings:

FIG. 1 shows a diagram of a substrate with an RFID tag fabricated thereon, according to an embodiment of the invention.

FIGS. 2A and 2B show a diagram of an integrated circuit package, according to an embodiment of the invention.

FIG. 3 shows a diagram of a wafer, according to an embodiment of the invention.

FIG. 4 shows a diagram of a single-die area on a wafer, according to an embodiment of the invention.

FIG. 5 shows a flow diagram of a method of fabricating dice with RFID tags, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, the different embodiments described my have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces and/or antennas that transmit and/or receive those signals, etc.), and others.

This document may use terms that may have slightly different meanings in various other documents, depending on the writer or intended audience. However, within the context of this document, the following terms shall have the following meanings:

Substrate—a planar object suitable for fabricating circuitry within the object or on the surface of the object. In particular, a substrate may be any of: 1) a wafer on which multiple integrated circuits (ICs) may be fabricated, 2) a die (a portion of the wafer which has been separated from the wafer to form an individual IC), or 3) a package substrate (to which a die is physically and electrically attached to form an IC package).

Fabrication—the formation of a circuit on a substrate through such techniques as deposition, etching, and implantation. Physically attaching a pre-manufactured solid element to a substrate is not considered fabrication in this document, although it may be performed in addition to fabrication.

Single-die area—the area of a wafer that is devoted to the fabrication of a single die.

Die fabrication area—the area of a wafer that is devoted to the fabrication of multiple dice. The die fabrication area may include numerous single-die areas.

Scribe line—a real or imaginary line that marks the separation point between physically adjacent dice on a wafer. The scribe lines may be partially or completely destroyed when the wafer is cut into multiple dice.

RFID antenna—the antenna for an RFID tag for receiving radiated electromagnetic energy and sending a response.

RFID tag circuit—the circuitry, exclusive of antenna, that permits an RFID device to generate a modulated identifying signal in response to radiated electromagnetic energy received through the RFID antenna. The RFID tag circuit may be powered by the electromagnetic energy received through the RFID antenna.

RFID tag—the combination of an RFID tag circuit coupled to an RFID antenna.

Various embodiments of the invention may relate to RFID tags (or alternately just the RFID antennas for those tags) that are fabricated onto substrates in various ways. In some embodiments the RFID tags may be fabricated on a wafer and become operational before fabrication of other circuits on the wafer have been completed. Some such RFID tags may be located in individual single-die areas, for possible use before and/or after the fabrication operations have been completed, while other such RFID tags may be located on the wafer external to the die fabrication area, to be used to identify the wafer.

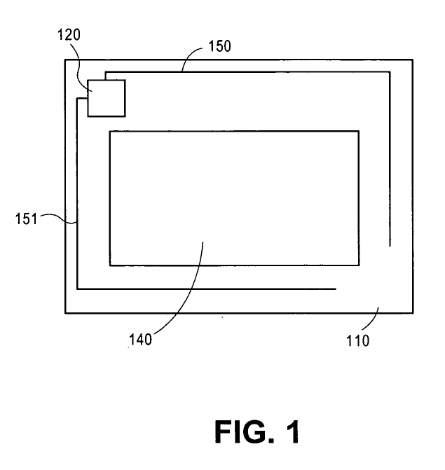

FIG. 1 shows a diagram of a substrate with an RFID tag fabricated thereon, according to an embodiment of the invention. Substrate 110 may be any of various types of substrates, such as but not limited to: 1) a die, 2) the portion of a wafer represented by a single-die area before the wafer has been cut into multiple dice, 3) a package substrate to which a separate IC is to be attached, 4) etc. In the illustrated embodiment, RFID tag circuit 120 has been fabricated on the substrate 110, with antenna elements 150, 151 also fabricated on the substrate. Circuit area 140 may also be fabricated on the substrate 110, in the form of circuitry that must have a physically-connected source of power to operate, and which may or may not be electrically coupled to the RFID tag circuit 120.

Although the illustrated embodiment shows them, in different embodiments, circuit area 140 and/or RFID tag circuit 120 may not be present on substrate 110. The antenna elements 150, 151 that form the RFID antenna are shown as two separate antenna elements that are near the periphery of the substrate, but other embodiments are also possible. One, three, or more RFID antenna elements may be present. The path followed by the antenna element(s) may also follow routes other than the one shown.

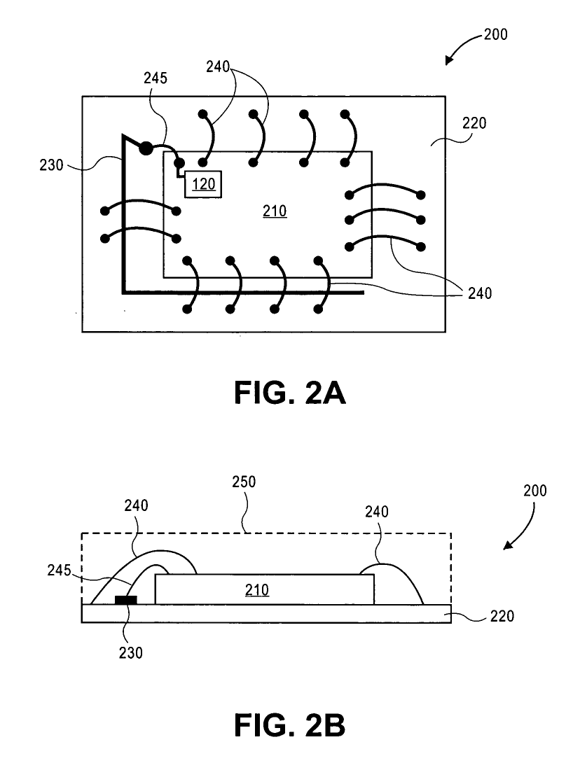

FIGS. 2A and 2B show a diagram of an integrated circuit package, according to an embodiment of the invention. FIG. 1A shows a top view, while FIG. 2B shows a side view. IC package 200 may comprise a package substrate 220 to which is attached a die 210, with an RFID circuit 120 fabricated on the die and an RFID antenna 230 disposed on package substrate 220. In the illustrated embodiment bond wires 240 may be used to electrically connect bond pads on the die and package substrate to each other, but other embodiments may use other techniques, such as but not limited to direct solder connections. A bond wire 245 or other connection technique may also be used to connect the RFID circuit 120 to RFID antenna 230. In some embodiments, multiple connections may be used to connect the RFID circuit 120 to multiple RFID antenna elements. The RFID antenna 230 may created in various ways, such as but not limited to: 1) fabricating the antenna 230 on the package substrate as a metal trace, 2) suspending an antenna wire in encapsulating material 250, with the antenna wire attached to an antenna connection on substrate 220 or die 210, 3) etc.

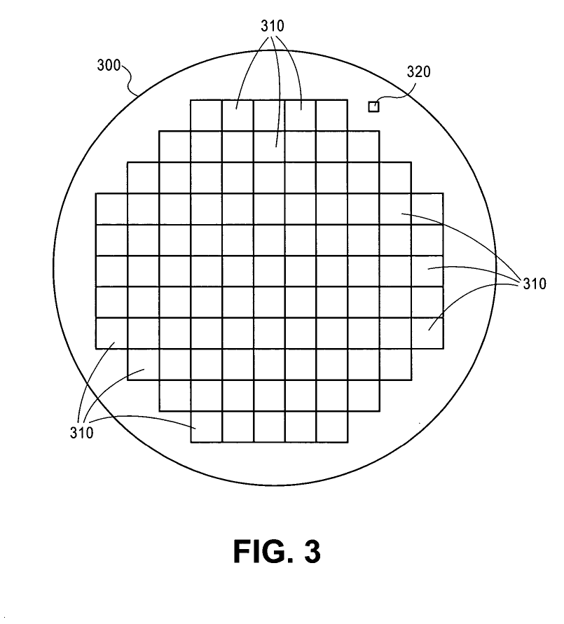

FIG. 3 shows a diagram of a wafer, according to an embodiment of the invention. In the illustrated embodiment, wafer 300 has an array of multiple single-die areas 310 in which individual IC dice may be fabricated. The multiple single-die areas 310 on wafer 300 may collectively make up the die fabrication area. After fabrication of the circuits on the individual single-die areas, the wafer may be cut into individual dice along the scribe lines that separate the individual single-die areas from each other.

Each single-die area may have an RFID tag fabricated therein, which after it is operational, may be used to identify the individual die or single-die area. Another RFID tag 320 may be fabricated outside the die fabrication area to identify the wafer as a whole without respect to individual single-die areas. In some embodiments each RFID tag on the wafer may have a unique identifying number, for separate identification of the respective tagged areas. In other embodiments, multiple RFID tags may have the same identifying number to simply associate them with a group, such as but not limited to a manufacturing lot number.

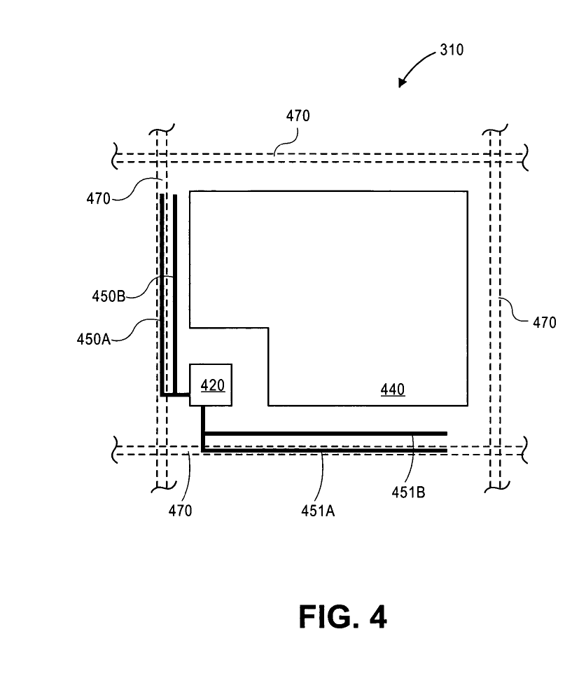

FIG. 4 shows a diagram of a single-die area on a wafer, according to an embodiment of the invention. In the illustrated single-die area 310, which may be one of those shown in FIG. 3, the single-die area may be circumscribed by scribe lines 470. After all the fabrication operations have been completed, the wafer may be separated into individual dice by cutting along these scribe lines. In the illustrated embodiment the scribe lines are shown to have a width greater than the antenna elements 450A, 451A, and equal to the thickness of the saw blade, so that the antenna elements 450A, 451A may be destroyed by the cutting operation. Before the cutting operation, however, individual circuits may be fabricated onto the wafer, such as RFID tag circuit 420 and circuit 440. Circuit 440 may comprise any feasible circuitry, such as the circuitry for a microprocessor, a memory, a graphics controller, etc. In some embodiments, circuit 440 is a circuit that requires being connected to a power source before it will operate.

Antenna elements 450A and 451A may be an alternative antenna configuration to antenna elements 450B and 451B. Although both are shown in FIG. 4 for completeness, in many embodiments only one configuration or the other would be implemented for a single-die area. Antenna elements 450A, 451A are shown on the scribe lines, which may be destroyed when the wafer is cut into dice. In this embodiment, the RFID tag may be operational (i.e., it may operate in the intended manner when it receives electromagnetic radiation with the proper characteristics) after it is fabricated and before the wafer is cut into dice, but the dice cutting operation may destroy the antenna elements and thereby make the RFID tag inoperable. The RFID tag may be made operational again, however, if the RFID tag circuit is subsequently electrically connected to an RFID antenna external to the die, such as on a package substrate. In the other illustrated embodiment, RFID antenna elements 450B and 451B are located inside the scribe lines, within the single-die area, and may still be connected to the RFID tag circuit after the die cutting operation so that the RFID tag may still be operable after the individual dice are created.

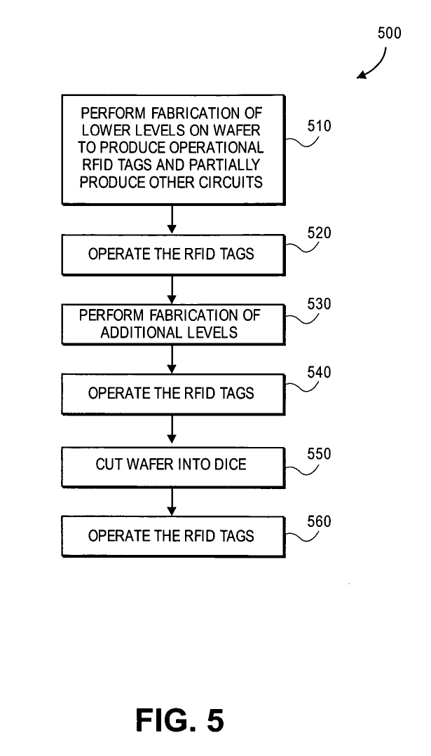

FIG. 5 shows a flow diagram of a method of fabricating dice with RFID tags, according to an embodiment of the invention. Many IC fabrication processes require numerous processing steps to fabricate circuitry on a wafer. Multiple tens of steps (e.g., on the order of 20, 30, 40 or more) may be required to produce dense, complex integrated circuits. In the method of flow chart 500, at 510 the initial processing steps that fabricate the lower levels of circuitry may produce an operational RFID tag, even though other more complex circuitry may require many more fabrication steps, so that the more complex circuitry is only partially fabricated when the RFID tag is completely fabricated. In some embodiments a separate RFID tag may be fabricated in each single-die area, so that the circuitry being fabricated for each subsequently-produced die will have an associated operational RFID tag after only a few fabrication steps.

At 520, an RFID reader may direct electromagnetic radiation having the proper characteristics towards the wafer, and read the identification numbers of the RFID tags that are now operational on the wafer. In some embodiments each RFID tag will respond with a unique identification number, so that each single-die area will have an associated unique RFID identifier. Because RFID tags can be operated without a directly-connected power source, and because RFID technology does not require line-of-sight operation, this operation may be performed while the wafer is still in a processing chamber or other fabrication enclosure, by an RFID reader that is external to the chamber or enclosure.

After reading the RFID tags at 520, additional levels of fabrication may be performed at 530. In some embodiments these additional levels may complete the fabrication of the circuits. The RFID tags may be operated again at 540 for any feasible purpose, such as but not limited to storing intermediate fabrication status. Such operations may be performed as many times as needed, before and/or after completion of the additional fabrication operations of 530. Following completion of the fabrication operations, the wafer may be cut into individual dice at 550, with each die including an operational RFID tag.

Once separated, the individual dice might no longer maintain the orderly physical arrangement that they had while part of a wafer. But another reading operation at 560 may allow the individual dice to identify themselves again to an RFID reader, either one at a time or in groups. The identification operations performed at 520 and 560 may be used for any feasible purpose. Subsequent readings may also allow identification of individual dice during subsequent manufacturing, assembly, and distribution operations.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus comprising
a wafer comprising
a radio frequency identification (RFID) tag circuit fabricated on the wafer; and
an RFID antenna fabricated on the wafer and electrically coupled to the RFID tag circuit.

2. The apparatus of claim 1, wherein:
the wafer further comprises a second circuit; and
the RFID tag circuit is contained in fabrication layers that enable the RFID tag circuit to be operational before completion of fabrication of the second circuit.

3. The apparatus of claim 2, wherein:
the second circuit is electrically coupled to the RFID tag circuit.

4. The apparatus of claim 1, wherein the RFID tag circuit and the RFID antenna are disposed external to a die fabrication area on the wafer.

5. The apparatus of claim 1, wherein the RFID tag circuit is disposed internal to a single-die area on the wafer.

6. The apparatus of claim 5, wherein the RFID antenna is at least partially disposed on a scribe line for the single-die area.

7. The apparatus of claim 5, wherein the RFID antenna is disposed inside scribe lines for the single-die area.

8. A method, comprising:
performing fabrication operations on a wafer sufficient to produce an operational radio frequency identification (RFID) tag in each of multiple single-die areas of the wafer and sufficient to partially produce circuits in each of the multiple single-die areas of the wafer;
wherein the fabrication operations are insufficient to complete fabrication of the circuits.

9. The method of claim 8, further comprising operating the RFID tags subsequent to said performing fabrication operations to determine identifiers of the RFID tags.

10. The method of claim 9, further comprising performing, subsequent to said operating, additional fabrication operations on the wafer to further produce the circuits.

11. The method of claim 10, further comprising cutting the wafer into individual dice subsequent to said performing additional fabrication operations.

12. The method of claim 11, further comprising operating the RFID tags again subsequent to said cutting.

13. An apparatus comprising
an integrated circuit package comprising:
a integrated circuit die including a radio frequency identification (RFID) tag circuit;
an integrated circuit package substrate coupled to the integrated circuit die; and
an RFID antenna coupled to the RFID tag circuit.

14. The apparatus of claim 13, wherein the RFID antenna comprises a metal trace disposed on the integrated circuit package substrate.

15. The apparatus of claim 13, wherein the RFID antenna comprises a wire substantially not in physical contact with the integrated circuit package substrate.

16. An apparatus, comprising
a substrate comprising an antenna for a radio frequency identification (RFID) tag fabricated thereon.

17. The apparatus of claim 16, wherein the substrate is one of an integrated circuit die and an integrated circuit package substrate.

18. The apparatus of claim 16, wherein the substrate further comprises an RFID tag circuit.
